(19) United States
(12) Patent Application Publication
(10) Pub. No.: US 2026/0155601 A1
(43) Pub. Date: Jun. 4, 2026

(54) POSITION RETAINING MEMBER, CONNECTOR AND CONNECTOR ASSEMBLY

(71) Applicants: Tyco Electronics (Suzhou) Ltd., Suzhou City (CN); Tyco Electronics (Shanghai) Co., Ltd., Shanghai (CN)

(72) Inventors: Kang Zhou, Suzhou (CN); Jun Zong, Shanghai (CN); Tao (Thomson) Dong, Suzhou (CN)

(73) Assignees: Tyco Electronics (Suzhou) Ltd., Suzhou City (CN); Tyco Electronics (Shanghai) Co., Ltd., Shanghai (CN)

(21) Appl. No.: 19/400,626

(22) Filed: Nov. 25, 2025

(30) Foreign Application Priority Data
Nov. 29, 2024 (CN) 202422944307.9

(51) Int. Cl. H01R 13/627

(52) U.S. Cl. CPC H01R 13/627

(57) ABSTRACT

A position retaining member is adapted to be inserted into a connector housing and adapted to be moved between a final lock position and a pre lock position. The position retaining member includes a cantilever part and a pressing part. When the position retaining member is in the final lock position, the cantilever part is adapted to be pressed against an elastic buckle of the connector housing to hold the elastic buckle in a locking position engaged with a protrusion of a mating housing of a mating connector. When the position retaining member is in the pre lock position, the pressing part is adapted to press the elastic buckle to an unlocking position separated from the protrusion of the mating housing, allowing the connector housing to be pulled out from the mating housing.

### CROSS-REFERENCE TO RELATED APPLICATION

This application claims the benefit of Chinese Patent Application No. CN202422944307.9 filed on Nov. 29, 2024 in the State Intellectual Property Office of China, the whole disclosure of which is incorporated herein by reference.

### FIELD OF THE INVENTION

The disclosure relates to a position retaining member, a connector comprising the position retaining member, and a connector assembly comprising the connector.

### BACKGROUND OF THE INVENTION

In the prior art, after the connector and mating connector are mated, the elastic buckle on the connector housing engages with the protrusion inside the mating housing of the mating connector to lock the connector and mating connector together. When it is necessary to pull the connector out of the mating connector, one finger needs to press the unlocking part of the elastic buckle, while using the other finger to pull out the connector housing outward. However, due to the small size of the connector, while pressing the unlocking part of the elastic buckle with one finger, only the other finger can be used to pull out the connector housing. This makes it very difficult to unplug the connector.

### SUMMARY OF THE INVENTION

According to an embodiment of the present disclosure, a position retaining member is adapted to be inserted into a connector housing and adapted to be moved between a final lock position and a pre lock position. The position retaining member includes a cantilever part and a pressing part. When the position retaining member is in the final lock position, the cantilever part is adapted to be pressed against an elastic buckle of the connector housing to hold the elastic buckle in a locking position engaged with a protrusion of a mating housing of a mating connector. When the position retaining member is in the pre lock position, the pressing part is adapted to press the elastic buckle to an unlocking position separated from the protrusion of the mating housing, allowing the connector housing to be pulled out from the mating housing.

### BRIEF DESCRIPTION OF DRAWINGS

The above and other features of the present invention will become more apparent by describing in detail exemplary embodiments thereof with reference to the accompanying drawings, in which:

FIG. 1 shows an illustrative perspective view of a connector assembly according to an exemplary embodiment of the present invention;

FIG. 2 shows a vertical sectional view of a connector assembly according to an exemplary embodiment of the present invention, with the position retaining member in the final lock position;

FIG. 3 shows a vertical sectional view of a connector according to an exemplary embodiment of the present invention;

FIG. 4 shows an illustrative exploded view of a connector according to an exemplary embodiment of the present invention;

FIG. 5 shows a horizontal sectional view of a connector according to an exemplary embodiment of the present invention;

FIG. 6 shows a vertical sectional view of a connector assembly according to an exemplary embodiment of the present invention, with the position retaining member in the final lock position;

FIG. 7 shows a vertical sectional view of a connector assembly according to an exemplary embodiment of the present invention, with the position retaining member in a pre lock position;

FIG. 8 shows a horizontal sectional view of a connector assembly according to an exemplary embodiment of the present invention, with the position retaining member in the final lock position; and

FIG. 9 shows a horizontal sectional view of a connector assembly according to an exemplary embodiment of the present invention, with the position retaining member in a pre lock position.

The features disclosed in this disclosure will become more apparent in the following detailed description in conjunction with the accompanying drawings, where similar reference numerals always identify the corresponding components. In the accompanying drawings, similar reference numerals typically represent identical, functionally similar, and/or structurally similar components. Unless otherwise stated, the drawings provided throughout the entire disclosure should not be construed as drawings drawn to scale.

### DETAILED DESCRIPTION

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to an embodiment of the present disclosure, a position retaining member is adapted to be inserted into a connector housing and adapted to be moved between a final lock position and a pre lock position. The position retaining member comprises a cantilever part and a pressing part. When the position retaining member is in the final lock position, the cantilever part is pressed against an elastic buckle of the connector housing to hold the elastic buckle in a locking position engaged with a protrusion of a mating housing of a mating connector; when the position retaining member is in the pre lock position, the pressing part presses the elastic buckle to an unlocking position separated from the protrusion of the mating housing, allowing the connector housing to be pulled out from the mating housing.

According to another embodiment, a connector comprises a connector housing which is formed with a slot and an elastic buckle suspended in the slot; and the above position retaining member which is inserted into the slot of the connector housing and can be moved along a longitudinal direction between a final lock position and a pre lock position. When the position retaining member is in the final lock position, the cantilever part is pressed against the elastic buckle to hold the elastic buckle in the locking position engaged with a protrusion of a mating housing of a mating connector; when the position retaining member is in the pre lock position, the pressing part presses the elastic buckle to an unlocking position separated from the protrusion of the mating housing, allowing the connector housing to be pulled out from the mating housing.

According to another embodiment, a connector assembly includes the above connector, and a mating connector which is mated with the connector. The mating connector comprises a mating housing, wherein the connector housing is inserted into the mating housing and a protrusion is formed in the mating housing; when the position retaining member is in the final lock position, the elastic buckle is in a locking position engaged with the protrusion and held in the locking position by the position retaining member to prevent the elastic buckle from being accidentally unlocked; when the position retaining member is moved from the final lock position to the pre lock position, the elastic buckle is pressed by the position retaining member to the unlocking position separated from the protrusion, allowing the connector housing to be pulled out from the mating housing.

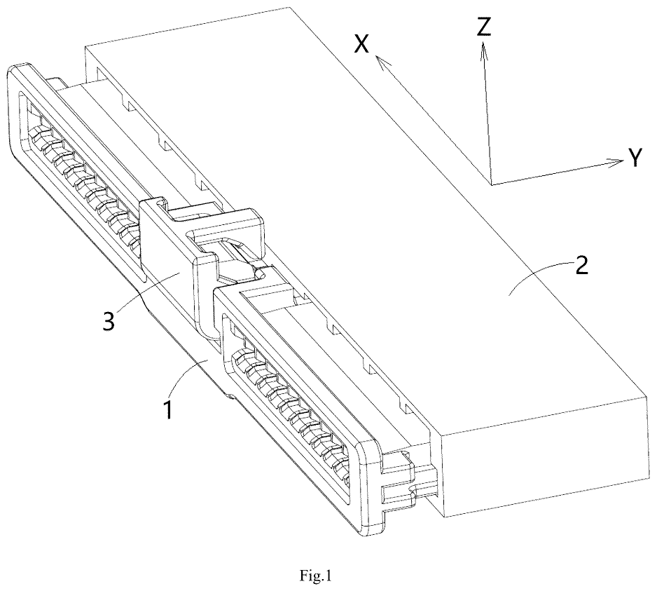

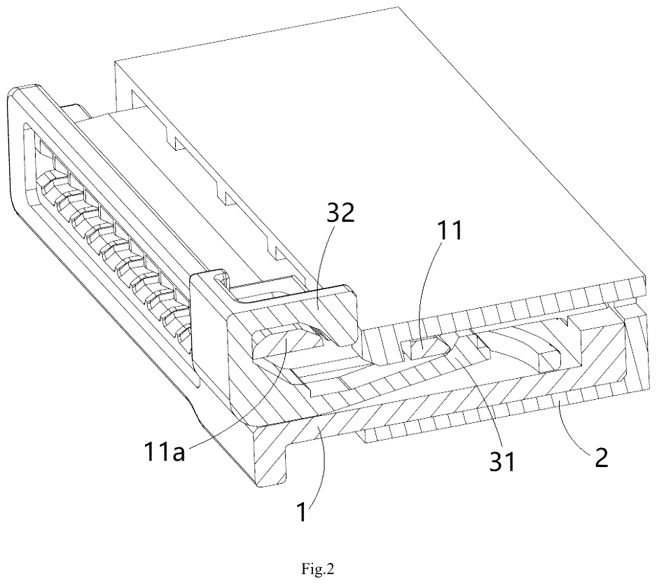

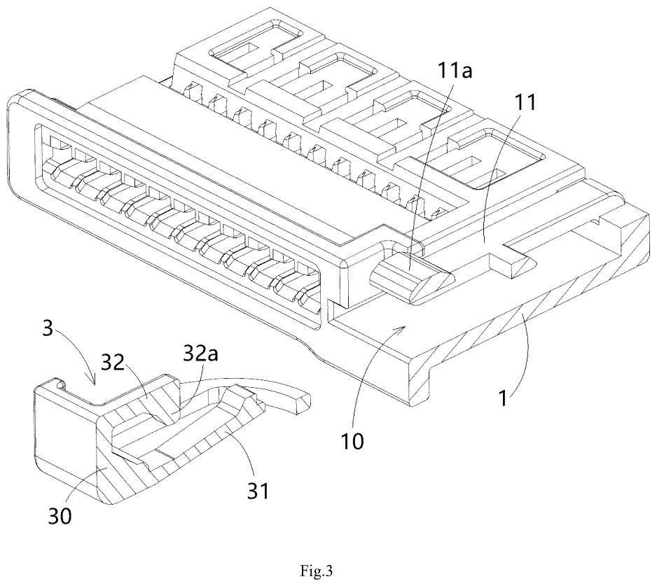

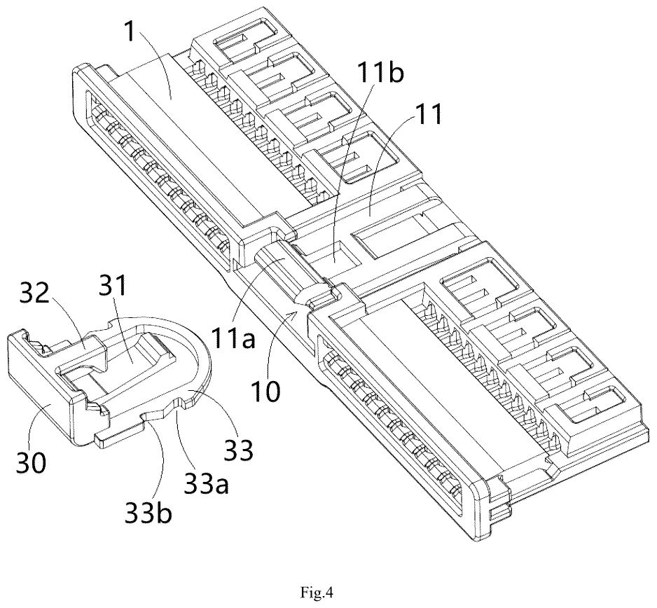

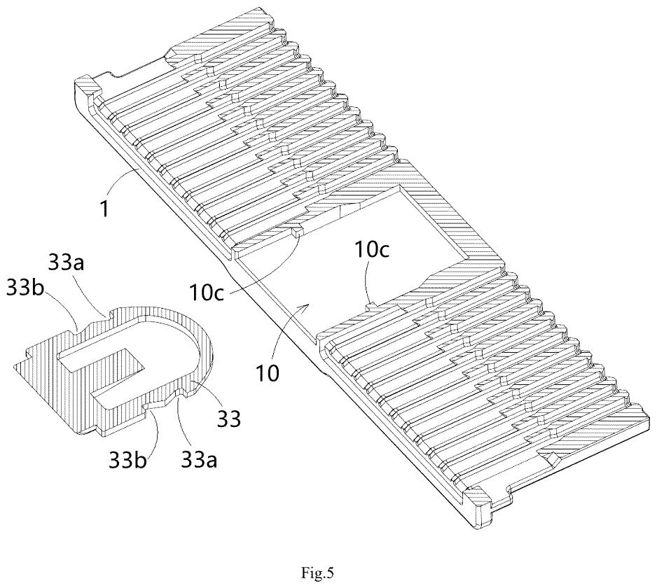

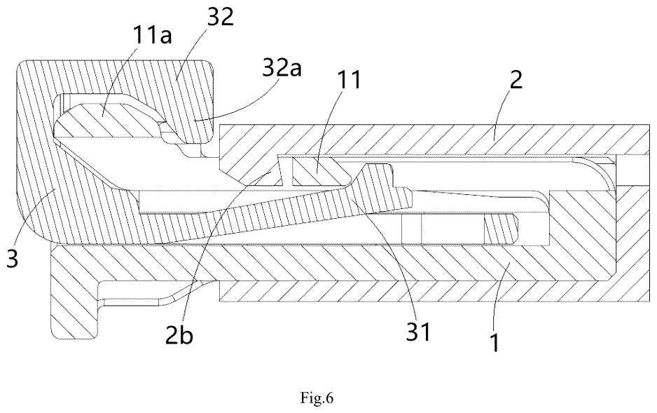

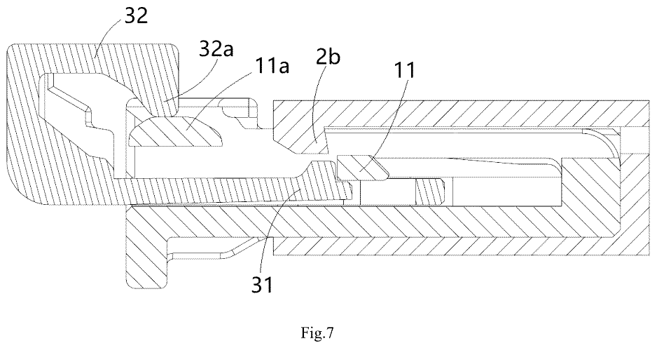

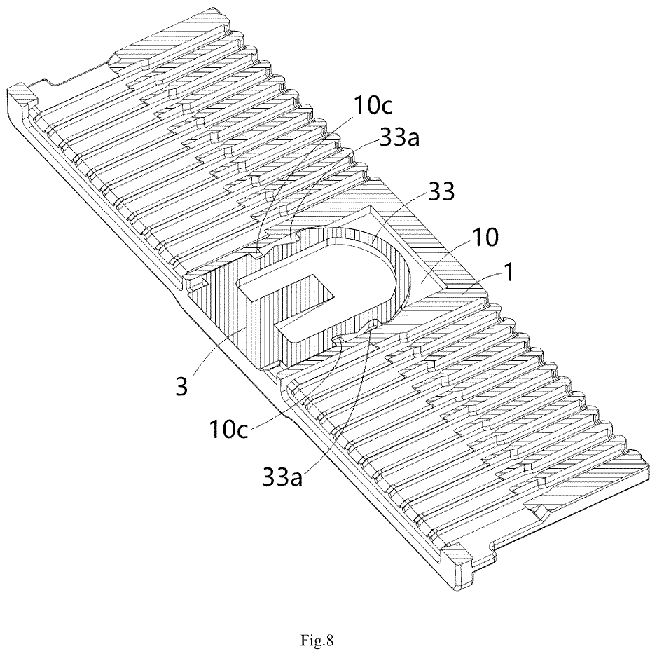

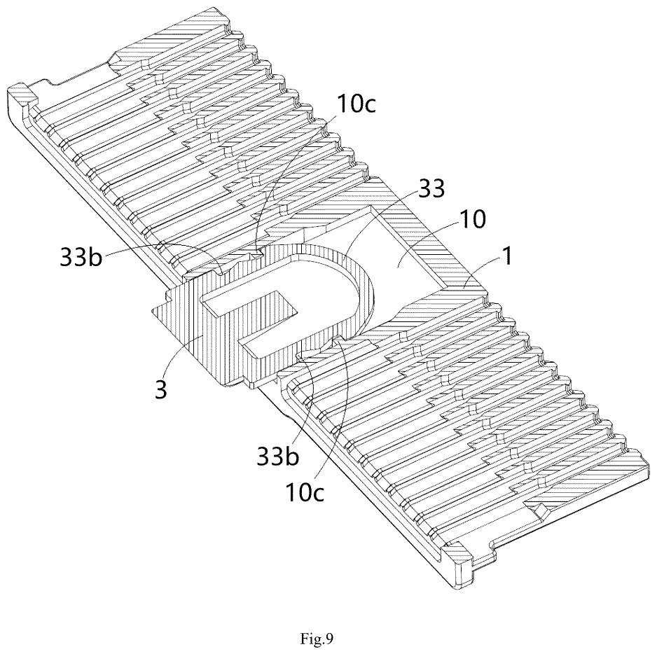

FIG. 1 shows an illustrative perspective view of a connector assembly according to an exemplary embodiment of the present invention. FIG. 2 shows a vertical sectional view of a connector assembly according to an exemplary embodiment of the present invention, with the position retaining member 3 in the final lock position. FIG. 3 shows a vertical sectional view of a connector according to an exemplary embodiment of the present invention. FIG. 4 shows an illustrative exploded view of a connector according to an exemplary embodiment of the present invention. FIG. 5 shows a horizontal sectional view of a connector according to an exemplary embodiment of the present invention. FIG. 6 shows a vertical sectional view of a connector assembly according to an exemplary embodiment of the present invention, with the position retaining member 3 in the final lock position. FIG. 7 shows a vertical sectional view of a connector assembly according to an exemplary embodiment of the present invention, with the position retaining member 3 in a pre lock position. FIG. 8 shows a horizontal sectional view of a connector assembly according to an exemplary embodiment of the present invention, with the position retaining member 3 in the final lock position. FIG. 9 shows a horizontal sectional view of a connector assembly according to an exemplary embodiment of the present invention, with the position retaining member 3 in a pre lock position.

As shown in FIGS. 1-9, in an exemplary embodiment of the present invention, a position retaining member 3 is disclosed. The position retaining member 3 is adapted to be inserted into a connector housing 1 and adapted to be moved between a final lock position and a pre lock position. The position retaining member 3 includes a cantilever part 31 and a pressing part 32. When the position retaining member 3 is in the final lock position, the cantilever part 31 is pressed against an elastic buckle 11 of the connector housing 1 to hold the elastic buckle 11 in a locking position engaged with a protrusion 2b of a mating housing 2 of a mating connector. This can prevent the elastic buckle 11 from being accidentally unlocked. When the position retaining member 3 is in the pre lock position, the pressing part 32 presses the elastic buckle 11 to an unlocking position separated from the protrusion 2b of the mating housing 2, allowing the connector housing 1 to be pulled out from the mating housing 2.

In the illustrated embodiment, the position retaining member 3 further comprises a rear seat body 30, which is connected to the cantilever part 31 and the pressing part 32. The cantilever part 31 and the pressing part 32 extend forward from the rear seat body 30 and are spaced apart from each other in the height direction Z. The pressing part 32 is located above the cantilever part 31, and the pressing part 32 is in a cantilever shape with a downward protruding pressing protrusion 32a. When the position retaining member 3 is in the pre lock position, the pressing protrusion 32a presses the unlocking part 11a of the elastic buckle 11 downward, so that the elastic buckle 11 is pressed to the unlocking position. When the position retaining member 3 is in the final lock position, the pressing protrusion 32a separates from the unlocking part 11a of the elastic buckle 11 to allow the elastic buckle 11 to automatically reset to the locking position.

The position retaining member 3 also includes a frame body 33. The frame body 33 is connected to the rear seat body 30 and extends forward along the longitudinal direction Y from the rear seat body 30. On opposite sides of the frame body 33 in the transverse direction X, there are pre locking slots 33a and final locking slots 33b located behind the pre locking slots 33a. The pre locking slot 33a is used to engage with the retaining protrusion 10c inside the connector housing 1 to hold the position retaining member 3 in the pre lock position. The final locking slot 33b is used to engage with the retaining protrusion 10c inside the connector housing 1 to hold the position retaining member 3 in the final lock position. The frame body 33 is U-shaped and its open end is connected to the rear seat body 30, and the cantilever part 31 is suspended in the U-shaped frame body 33. In the illustrated embodiment, the position retaining member 3 is an integral injection molded part, which can reduce manufacturing costs.

As shown in FIGS. 1-9, in another exemplary embodiment of the present disclosure, a connector is also disclosed. The connector includes a connector housing 1 and the position retaining member 3. The connector housing 1 is formed with a slot 10 and an elastic buckle 11 suspended in the slot 10. The position retaining member 3 is inserted into the slot 10 of the connector housing 1 and can be moved along the longitudinal direction Y between the final lock position and the pre lock position.

As shown in FIGS. 2 and 6, in the illustrated embodiment, when the position retaining member 3 is in the final lock position, the cantilever part 31 rests against the elastic buckle 11 to hold the elastic buckle 11 in the locking position engaged with the protrusion 2b of the mating housing 2 of the mating connector. This can prevent the elastic buckle 11 from being accidentally unlocked. When the position retaining member 3 is in the pre lock position, the pressing part 32 presses the elastic buckle 11 to the unlocking position separated from the protrusion 2b of the mating housing 2, allowing the connector housing 1 to be pulled out from the mating housing 2.

As shown in FIGS. 1-9, in the illustrated embodiment, the elastic buckle 11 has an unlocking part 11a located at its rear end and protruding upwards. When the position retaining member 3 is in the pre lock position, the pressing part 32 presses downwards on the unlocking part 11a of the elastic buckle 11 to press the elastic buckle 11 to the unlocking position. When the position retaining member 3 is in the final lock position, the pressing part 32 separates from the unlocking part 11a of the elastic buckle 11 to allow the elastic buckle 11 to automatically reset to the locking position.

A retaining protrusion 10c is formed on each of two inner walls of the slot 10 of the connector housing 1 that are opposite to each other in the transverse direction X. When the position retaining member 3 is in the pre lock position, the retaining protrusion 10c engages with the pre locking slot 33a on the position retaining member 3 to keep the position retaining member 3 in the pre lock position. When the position retaining member 3 is in the final lock position, the retaining protrusion 10c engages with the final locking slot 33b on the position retaining member 3 to hold the position retaining member 3 in the final lock position. A snap slot 11b suitable for engaging with the protrusion 2b inside the mating housing 2 is formed on the elastic buckle 11, for locking the connector housing 1 to the mating housing 2.

In the illustrated embodiment, the connector also includes a terminal. The terminal is set in the connector housing 1 for mating with a mating terminal set in the mating housing 2.

A connector assembly is also disclosed. The connector assembly includes the connector and a mating connector. The mating connector is mated with the connector. The mating connector includes a mating housing 2. The connector housing 1 is inserted into the mating housing 2. A protrusion 2b is formed in the mating housing 2.

When the position retaining member 3 is in the final lock position, the elastic buckle 11 is in the locking position engaged with the protrusion 2b and held in the locking position by the position retaining member 3 to prevent the elastic buckle 11 from being accidentally unlocked. When the position retaining member 3 is moved from the final lock position to the pre lock position, the elastic buckle 11 is pressed by the position retaining member 3 to the unlocking position separated from the protrusion 2b, allowing the connector housing 1 to be pulled out from the mating housing 2.

In the illustrated embodiment, the mating connector further includes a mating terminal. The mating terminal is set in the mating housing 2. The terminal of the connector is mated with the mating terminal of the mating connector to achieve electrical connection between the two.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A position retaining member, comprising:
a cantilever part; and
a pressing part, wherein:
the position retaining member is adapted to be inserted into a connector housing and adapted to be moved between a final lock position and a pre lock position;
when the position retaining member is in the final lock position, the cantilever part is adapted to be pressed against an elastic buckle of the connector housing to hold the elastic buckle in a locking position engaged with a protrusion of a mating housing of a mating connector; and
when the position retaining member is in the pre lock position, the pressing part is adapted to press the elastic buckle to an unlocking position separated from the protrusion of the mating housing, allowing the connector housing to be pulled out from the mating housing.

2. The position retaining member according to claim 1, further comprising a rear seat body connected to the cantilever part and the pressing part, the cantilever part and the pressing part extend forward from the rear seat body and are spaced apart from each other in a height direction.

3. The position retaining member according to claim 2, wherein the pressing part is located above the cantilever part, and the pressing part is in a cantilever shape with a downward protruding pressing protrusion.

4. The position retaining member according to claim 3, wherein, when the position retaining member is in the pre lock position, the pressing protrusion presses downward on an unlocking part of the elastic buckle, causing the elastic buckle to be pressed to the unlocking position.

5. The position retaining member according to claim 4, wherein, when the position retaining member is in the final lock position, the pressing protrusion separates from the unlocking part of the elastic buckle to allow the elastic buckle to automatically reset to the locking position.

6. The position retaining member according to claim 2, further comprising a frame body connected to the rear seat body and extending forward along a longitudinal direction from the rear seat body.

7. The position retaining member according to claim 6, wherein a pre locking slot and a final locking slot located behind the pre locking slot are formed on each of opposite sides of the frame body in the transverse direction.

8. The position retaining member according to claim 7, wherein the pre locking slot is used to engage with a retaining protrusion inside the connector housing to hold the position retaining member in the pre lock position.

9. The position retaining member according to claim 8, wherein the final locking slot is used to engage with the retaining protrusion inside the connector housing to hold the position retaining member in the final lock position.

10. The position retaining member according to claim 8, wherein the frame body is U-shaped and its open end is connected to the rear seat body, and the cantilever part is suspended in the U-shaped frame body.

11. The position retaining member according to any one of claims 1, wherein the position retaining member is an integral injection molded part.

12. A connector, comprising:
a connector housing formed with a slot and an elastic buckle suspended in the slot; and
a position retaining member inserted into the slot of the connector housing and movable along a longitudinal direction between a final lock position and a pre lock position, including:
a cantilever part; and
a pressing part, wherein:
when the position retaining member is in the final lock position, the cantilever part is pressed against an elastic buckle of the connector housing to hold the elastic buckle in a locking position engaged with a protrusion of a mating housing of a mating connector; and
when the position retaining member is in the pre lock position, the pressing part presses the elastic buckle to an unlocking position separated from the protrusion of the mating housing, allowing the connector housing to be pulled out from the mating housing.

13. The connector according to claim 12, wherein:
the elastic buckle has an unlocking part located at its rear end and protruding upwards;
when the position retaining member is in the pre lock position, the pressing part presses downward on the unlocking part of the elastic buckle to press the elastic buckle to the unlocking position; and
when the position retaining member is in the final lock position, the pressing part separates from the unlocking part of the elastic buckle to allow the elastic buckle to automatically reset to the locking position.

14. The connector according to claim 12, wherein:
a retaining protrusion is formed on each of two opposite inner walls of the slot of the connector housing in the transverse direction;
when the position retaining member is in the pre lock position, the retaining protrusion engages with the pre locking slot on the position retaining member to hold the position retaining member in the pre lock position; and
when the position retaining member is in the final lock position, the retaining protrusion engages with the final locking slot on the position retaining member to hold the position retaining member in the final lock position.

15. The connector according to claim 12, wherein a snap slot suitable for engaging with a protrusion inside the mating housing is formed on the elastic buckle for locking the connector housing to the mating housing.

16. The connector according to claim 12, further comprising a terminal which is set in the connector housing for mating with a mating terminal set in the mating housing.

17. A connector assembly, comprising:
the connector according to claim 12; and
a mating connector mated with the connector, wherein the mating connector comprises a mating housing, the connector housing is inserted into the mating housing and a protrusion is formed in the mating housing.

18. The connector assembly according to claim 17, wherein, when the position retaining member is in the final lock position, the elastic buckle is in a locking position engaged with the protrusion and held in the locking position by the position retaining member.

19. The connector assembly according to claim 18, wherein the mating connector further comprises a mating terminal set in the mating housing.

20. The connector assembly according to claim 19, wherein the terminal of the connector is mated with the mating terminal of the mating connector to achieve electrical connection between the two.
